(19) United States
(12) Patent Application Publication
(10) Pub. No.: US 2006/0164395 A1
(43) Pub. Date: Jul. 27, 2006

(54) Arrangement for integration of key illumination into keymat of portable electronic devices

(76) Inventors: James Eldon, Fleet (GB); Simon Lawton, Scunthorpe (GB)

Correspondence Address: HARRINGTON & SMITH, LLP, 4 RESEARCH DRIVE, SHELTON, CT, 06484-6212, US

(21) Appl. No.: 10/541,085

(22) PCT Filed: Dec. 18, 2003
(86) PCT No.: PCT/EP03/51067

§ 371 Date: Apr. 6, 2006

(30) Foreign Application Priority Data
Dec. 30, 2002 (GB) 0230298.2

(51) Int. Cl. G09G 5/00

(52) U.S. Cl. 345/168

(57) ABSTRACT

A keypad including a set of switches; a set of key elements each capable of being moved by a user so as to operate a respective switch; and a display device, the display pattern of from which can be varied under the control of a display controller, and arranged so as to be capable of propagating two or more patterns of light from at least some of the key elements; whereby indicia may be displayed from the key elements and the displayed indicia varied under the control of the display controller.

This invention relates to a keypad, especially a keypad suitable for multifunction operation.

Keypads comprise a number of keys that can be mechanically depressed by a user. Each key typically has a respective switch that is operated when the user presses it, to provide input to the device of which the keypad is part.

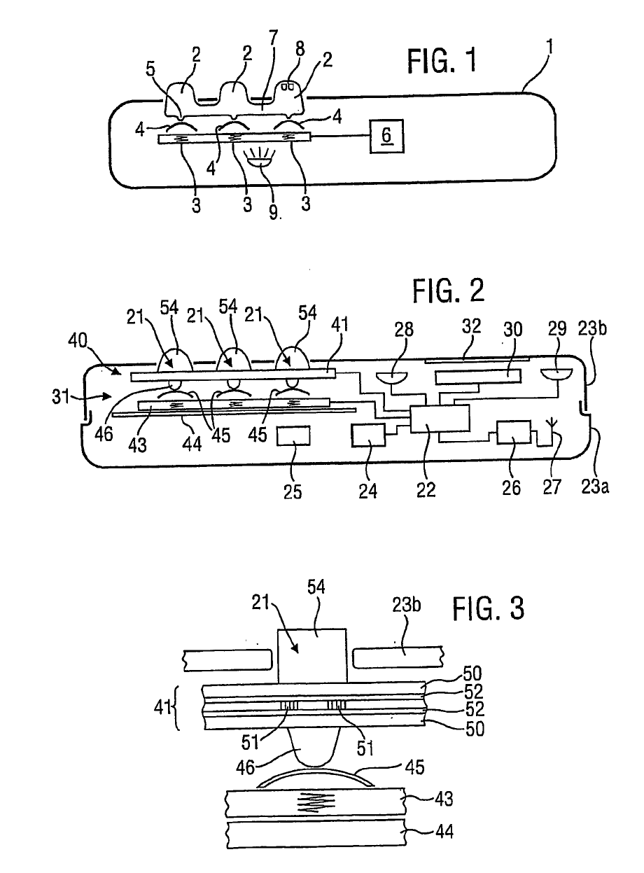

FIG. 1 is a cross-section of a typical membrane keypad. The keypad is set into the housing 1 of the device of which it is part. The keypad comprises a number of keys, each constituted by a key head 2, a membrane switch 3 and a dome spring 4. The key head has a neutral position as shown in the figure, in which it is biased outwardly relative to the housing by the dome spring 4. A user can press the key head inwardly relative to the housing, against the dome spring, to cause a nib 5 on the inner end of the key head to bear on the membrane switch and make a contact. The membrane switch is connected to a control processor 6 of the device, which can make use of the input provided by the switch.

To allow a user to distinguish between the keys of the keypad, the key heads normally have indicia marked on them or embedded into them. One popular arrangement is for the key heads to be formed integrally in a resilient mat 7 of translucent material such as silicone rubber. Embedded in the translucent material are regions 8 of a material that is dark-coloured and opaque. The regions 8 are in the shape of indicia appropriate to each key (for instance numbers). The dark-coloured regions are visible to a user of the keypad, and allow him to distinguish between the keys when the keypad is lit from the front. A backlight 9 can be set behind the keypad to provide uniform illumination to the underside of the mat 7. The light from the backlight does not pass through the opaque regions 8, with the result that even in dark conditions the user can still distinguish between the keys. Alternatively or in addition to marking indicia on the keys, indicia indicating the function of a key can be marked on the housing or on a non-key head region of the mat, in each case adjacent to the key in question.

Each key may have a dedicated function. However, it is more normal for the function performed by the device in response to the pressing of a key to depend on the state of the control processor 6 when the key is pressed. For example, in a mobile phone a key marked with the indicia “4” may perform the function of adding the digit “4” to a number to be dialled when the control processor of the phone is in a mode for entry of a phone number; the function of moving an icon to the left when the control processor of the phone is in a gaming mode; or the function of entering the character “g” when the phone is in an alphabetic entry mode. Indicating all the possible functions of a key to a user causes a number of problems.
1. Especially in relatively compact devices such as mobile phones there may simply not be enough space on the key heads or adjacent to them to mark all the possible functions in a legible way.
2. If many possible functions are marked on a key then the key may have so much information on it that a user cannot easily make use of it all.
3. Marking many possible functions on keys imposes restrictions on the design of the user interface that is to operate with the keypad. It might be desirable for one key to perform a “left” function in one situation and another key to perform the “left” function in another situation; but a user could be confused if “left” were marked on both of those keys.
4. The user might be able to upgrade the control processor to give it additional functionality. Any additional keypad functions that this introduces cannot generally be taken into account by marking the keys, since the functions are likely to have been unknown when the device was manufactured.

As a result, it is normal for only the most important functions to be marked on keys. This means that the user has to remember the keys' less important functions.

In devices that have built-in user displays it is known to locate one or more “soft” keys beside the display and for the control processor to control the display to display adjacent to the key the current function of the key. However, this uses up space on the user display, and it is generally only practical for a small number of keys, since locating all the keys next to a piece of the display would mean distorting the keypad to surround the display, which in turn would make it difficult to enter strings of data such as text or telephone numbers, and would mean that the user's hands obscured the display whilst entering data.

Another route is to use a touch-sensitive display screen. This can display virtual “keys” in selected regions of the display. However, an important usability advantage of keypads as described above is that their mechanical keys can provide tactile feedback to a user pressing a key, which enhances the user's impression of the keypad and reassures him that the key has been pressed. Since touch-screens not have mechanical keys they do not provide this tactile feedback.

There is a need for an improved way to indicate the function of the keys of a keypad to a user.

According to the present invention there is provided a keypad comprising: a set of switches; a set of key elements each capable of being moved by a user so as to operate a respective switch; and a display device, the display pattern of which can be varied under the control of a display controller, and arranged so as to be capable of propagating two or more patterns of light from at least some of the key elements; whereby indicia may be displayed from the key elements and the displayed indicia varied under the control of the display controller.

Preferably the display device is in the form of a flexible film.

Preferably the key elements are interconnected by the flexible film. The key elements may be adhered to or extend through the flexible film.

Preferably each key element comprises an outer pad for actuation by a user. The outer pad may be transparent. Preferably the display device is located between each outer pad and the respective switch. The indicia may be displayed from each respective key element.

The display device may be a light-emitting display device. Alternatively, the device may be a transmissive or a transflective display device. Each display pattern may be a pattern of light generated by and emitted from the display device, or may be a pattern of light generated externally to the device and transmitted through or reflected by the device.

According to a second aspect of the present invention there is provided an electronic device including a keypad as claimed in any preceding claim and the said display controller.

The display controller may be arranged to, in a first mode, cause the display device to display a first set of indicia through the key elements and, in a second mode, display a second set of indicia through the key elements. The first mode may be a numeric input mode, in which case the first set of indicia are preferably numeric indicia. The second mode may be an alphabetic input mode, in which case the first set of indicia are preferably alphabetic indicia. Preferably in the first and second modes the indicia displayed on each key is indicative of the character that would be input on pressing the key. Suitably, in the second mode the character that would be input on pressing the key is dependent on the number of times the key has been pressed within a predetermined time period of each previous such press without the pressing of another of the keys.

The present invention will now be described by way of example with reference o the accompanying drawings.

n the drawings:

FIG. 1 is a schematic cross-section of a first electronic device;

FIG. 2 is a schematic cross-section of a second electronic device; and

FIG. 3 is a schematic cross-section of part of a key mat of the device of FIG. 2.

In the device of FIGS. 2 and 3 there is a display device 41 set behind the pads 54 of the key heads 21. The control processor 22 can at any time vary the pattern of light emission from the display device 41 depending on the function of the keys. The pads 54 of the key heads are transparent so that a user can see the pattern of the display through the key heads, and so be informed of the keys' current functions.

The device of FIG. 2 is a mobile phone. However, this is just an example and the present keypad is not limited to use with mobile phones.

The mobile phone of FIG. 2 comprises a housing which is made of a rigid plastics material, and is formed of two parts: a rear part 23a and a front part 23b. The parts are fixed together to enclose most of the components of the phone. The front part of the housing has holes for the pads 54 of the key heads to protrude through, and a transparent window 32 though which a user can view user display 30 which is inside the housing. Also inside the housing are the control processor 22, a memory 24, a battery 25, a radio transceiver unit 26, an antenna 27, a microphone 28 and a loudspeaker 29. The function of these will be described below. Some components of the keypad, which is indicated generally at 31, are also inside the housing.

The keypad 31 comprises a key mat 40 composed of a flexible sheet display device 41, which is attached to a number of key heads 21 and constitutes a web which connects them together. When the sheet is in its natural state it lies in a plane and outer pads 54 of the key heads extend out of the plane in a direction that is towards the front of the phone when the mat is installed, as shown in FIG. 2. When the mat is installed the key heads extend out of the holes in the housing so that they may be pressed by a user inwards relative to the housing. Behind the mat 40 is a membrane switch unit 43, which incorporates individual switches for each key. The membrane switch unit rests on a rigid shelf 44, which is fixed to the housing. A dome spring 45 lies between each key head and the membrane switch unit. Each key head 21 has a nib 46 on its rear side. When, a key head is pressed inward relative to the housing the nib 46 of the key head bears on the dome spring and compresses it against the switch unit 43, which is restrained by the shelf 44. The nib forces the head of the dome spring against the membrane switch to make a contact in the membrane switch, and thereby provide an input to the control processor 22.

In the keypad of FIG. 2, the sheet 41 is a display device. Light-emitting zones of the display device are located in the sheet behind the pads 54 of the key heads. The pattern of light emission from the light-emitting zones can be controlled by the control processor 22. The pads 54 of the key heads are transparent. As a result, a user can see the light-emitting zones through the key heads.

FIG. 3 shows one of the key heads 21 and the neighbouring parts of the flexible sheet 41 in more detail. The flexible sheet comprises upper and lower encapsulating sheets 50. Between these, in the light-emitting zone of the key of FIG. 3, are a number of pixels 51 of light-emissive material. The pixels are located between upper and lower electrode layers 52 by means of which the pixels can be addressed and driven to emit light. The control processor 22 is connected to the electrode layers so that it can address the pixels and cause each one of them to be switched on when required.

The key head 21 is attached by adhesive to the flexible sheet 41 at the light-emitting zone. The outer pad 54 is attached on one side of the sheet and the nib 46 is attached on the other side. Another means of attachment is for There to be a hole through the sheet 41 at the centre of the light-emitting zone. The key head may then comprise the outer pad 54 and a leg extending from the bottom of the outer pad. The leg can have has a resilient plug at its distal end, which is sized to pass under compression through the hole in the sheet but then expand once it has been pushed through the hole, so as to resist removal of the leg from the hole. In use the plug can functions as the nib of the key head, for compressing the dome spring 45 when the key is pressed. The electrode layers 52 of the display sheet would be arranged to pass around the hole. Another means of attachment is for the key heads to be co-moulded through such holes.

The keys are mechanical in that a user can depress the keys by an appreciable amount (e.g. greater than 0.5 mm). The dome spring provides useful tactile feedback to a user. As a user puts increasing pressure on a key the dome spring first resists the pressure and then suddenly collapses to allow the nib to press the switch. This means that the user feels a sharp change in resistance from the key as it is pressed.

The nibs could be done away with if the configuration of the keypad were such that the dome spring could be pressed directly by the flexible sheet 41. The dome spring could be done away with if the flexible sheet 41 were sufficiently resilient for the key action desired.

In operation of the phone, the electrical components of the phone are powered by the battery 25. The control processor 22 performs application-related processing under the control of programme instructions stored in memory 24. The radio transceiver unit 26 receives signals from antenna 27, processes them to determine the data represented therein and passes that data to the control processor for subsequent processing. Data to be transmitted is passed to radio transceiver unit 26 by the control processor and appropriate signals are then transmitted by means of the antenna. A user's voice can be picked up by microphone 28 which provides input to the control processor to form data for transmission. Received audio data can be played through the loudspeaker 29. The control processor can control the display 30 to display user data such as locally composed messages, messages received via the radio transceiver unit, dialled telephone numbers, telephone numbers from which incoming calls have originated, and messages indicating the status of the mobile phone.

The operation of the control processor can be controlled, according to the instructions stored in the memory 24, by presses of the keys of the keypad. The instructions also include information defining how the processor is to control the light-emitting zones of the display sheet 41. The processor can thus control the zones depending on the state of the phone, by displaying on one or more of the keys indicia indicative of the function that will result if the key is pressed. The control processor acts as a display controller. Examples of the types of control that may take place are as follows:
1. When the phone is in a numeric input mode (when the keys will act to indicate input numbers) the control processor can control the zones to display on each key that will provide numeric input the number that will be input when that key is pressed.
2. When the phone is in an alphabetic or symbolic input mode (when the keys will act to indicate input letters or symbols) the control processor can control the zones to display on each key that will provide numeric input the letter(s) and or symbol(s) that will be input when that key is pressed. In many phones, alphabetic and symbolic characters are input by pressing a key one or more times, and the character that is input depends on the number of times a key is pressed in quick succession (i.e. within a predetermined time of the last press of the same key, without an intervening press of another key). In the present keypad the character displayed on the key could be the one that will be input if the key is pressed once at the current time. Thus this could vary depending on how many times the key has been pressed in quick succession.
3. When the phone is in a game mode (when the keys will act to perform dedicated in-game functions) the control processor can control the zones to display on each key that will provide in-game input an indication of the function that will apply when that key is pressed.

The keypad described above may be used in other device than phones. Non-limiting examples include media players, remote control units and personal computer keyboards. The keypad is especially advantageous in portable, hand-held and/or battery-powered devices, since there is often a preference for such devices to be small, and the present keypad allows keys to perform multiple functions with a high degree of usability.

Each of the light-emitting zones comprises a number of independently actuable display regions, or pixels. Each of those display regions can be actuated by the control processor either alone or in combination with one or more others of the display regions of the zone to display a desired sign. The pixels may be rectangular, preferably square, and preferably arranged in an orthogonal matrix. Alternatively the regions may be of arbitrary shapes, which may be more efficient for displaying certain signs.

The memory will generally comprise a non-volatile portion for storing programme instructions and a random access portion for use by the control processor as a temporary store. A user can download new instruction sets for the processor and store them in the non-volatile portion of memory. These instruction set may include instructions for controlling the light-emitting zones of the keypad.

The display may be a light-emitting display, as described above, or a transflective display, which emits reflected ambient light, or a transmissive display, which emits light from a backlight located in the housing of the phone. The flexible sheet 41 may be a single display device in the form of a flexible sheet, or may be a flexible sheet that incorporates a number of separate display devices, each located in one of the zones that is to be light-emitting. The flexible sheet incorporating the display devices would be a compound display device. Since the individual display devices of the compound display device could then be located only behind the pads of the key heads, which are generally substantially rigid, the display devices themselves can be non-flexible. The display device need not be in the form of a single sheet as described above: instead a compound display device may be constituted by individual display devices located in respective key heads, for example at or near the surface of the key heads.

The control processor may cause the loudspeaker to emit a noise (e.g. a click sound) when a key is pressed.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A keypad comprising: a set of switches;
a set of key elements each capable of being moved by a user so as to operate a respective switch; and
a display device, the display pattern of which can be varied under the control of a display controller, and arranged so as to be capable of propagating two or more patterns of light from at least some of the key elements;
whereby indicia may be displayed from the key elements and the displayed indicia varied under the control of the display controller.

2. A keypad as claimed in claim 1, wherein the display device is in the form of a flexible film.

3. A keypad as claimed in claim 2, wherein the key elements are interconnected by the flexible film.

4. A keypad as claimed in claim 1, wherein each key element comprises an outer pad for actuation by a user, and the display device is located between each outer pad and the respective switch.

5. A keypad as claimed in claim 4, wherein each outer pad is transparent.

6. A keypad as claimed in claim 1, wherein the display device is a light-emitting display device.

7. An electronic device including a keypad as claimed in claim 1 and the said display controller.

8. An electronic device as claimed in claim 7, wherein the display controller is arranged to, in a first mode, cause the display device to display a first set of indicia from each of the key elements and, in a second mode, display a second set of indicia from each of the key elements.

9. An electronic device as claimed in claim 8, wherein the first mode is a numeric input mode and the first set of indicia are numeric indicia, and the second mode is an alphabetic input mode and the first set of indicia are alphabetic indicia.

10. An electronic device as claimed in claim 9, wherein in the first and second modes the indicia displayed on each key is indicative of the character that would be input on pressing the key.

11. An electronic device as claimed in claim 10, wherein in the second mode the character that would be input on pressing the key is dependent on the number of times the key has been pressed within a predetermined time period of each previous such press without the pressing of another of the keys.

12. (canceled)

13. (canceled)
